(19) United States
(12) Patent Application Publication
(10) Pub. No.: US 2023/0174076 A1
(43) Pub. Date: Jun. 8, 2023

(54) VEHICLE CURATION SYSTEM AND VEHICLE CURATION METHOD

(71) Applicants: HYUNDAI MOTOR COMPANY, Seoul (KR); KIA CORPORATION, Seoul (KR)

(72) Inventors: Byeong Wook Jeon, Seoul (KR); Dong Hoon Jeong, Seongnam-si (KR); Min Jae Chai, Gwangmyeong-si (KR)

(73) Assignees: HYUNDAI MOTOR COMPANY, Seoul (KR); KIA CORPORATION, Seoul (KR)

(21) Appl. No.: 17/852,702

(22) Filed: Jun. 29, 2022

(30) Foreign Application Priority Data
Dec. 6, 2021 (KR) 10-2021-0173164

(51) Int. Cl. B60W 40/09; B60W 40/10

(52) U.S. Cl. CPC B60W 40/09; B60W 40/10; B60W 2540/30

(57) ABSTRACT

A vehicle curation system includes: a vehicle that obtains driving information of a driver, a server that obtains the driving information from the vehicle and stores the driving information for each driver and specification information of a new vehicle, and a curation device that receives driving information corresponding to driver information from the server when the driver information is input. In particular, the curation device determines driver driving tendencies and a vehicle character based on the specification information of the new vehicle, and further determines a curation target vehicle based on a similarity between the driver driving tendencies and the vehicle character.

### CROSS-REFERENCE TO RELATED APPLICATION

This application claims the benefit of and priority to Korean Patent Application No. 10-2021-0173164, filed in the Korean Intellectual Property Office on Dec. 6, 2021, the entire contents of which are incorporated herein by reference.

### TECHNICAL FIELD

The present disclosure relates to a vehicle curation system and a vehicle curation method.

### BACKGROUND

The statements in this section merely provide background information related to the present disclosure and may not constitute prior art.

Recently, as various types of new cars have been released, there is a practical limit in a driver's ability to obtain information on all vehicles and select a vehicle that matches his or her own tendencies.

When the driver selects a vehicle that matches his driving tendencies, he or she may be satisfied, but when the driver selects a vehicle that does not match his driving tendencies, he or she may not feel satisfaction from the initial stage of driving. We have found that it is desired to develop a technology for helping a driver to easily select a vehicle suitable for a driver's tendencies when purchasing a new vehicle.

### SUMMARY

The present disclosure has been made to solve the above-mentioned problems occurring in the prior art while advantages achieved by the prior art are maintained intact.

An aspect of the present disclosure provides a vehicle curation system and method for allowing a driver to select a vehicle that meets the driver's tendencies when purchasing a new vehicle.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, a vehicle curation system includes: a vehicle that obtains driving information of a driver, a server that obtains the driving information from the vehicle, and stores the driving information for each driver and specification information of a new vehicle, and a curation device that receives driving information corresponding to driver information from the server when the driver information is input. In particular, the curation device determines driver driving tendencies, and also determines a vehicle character based on the specification information of the new vehicle. In addition, the curation device further determines a curation target vehicle based on a similarity between the driver driving tendencies and the vehicle character.

In another embodiment, the curation device may set the driver driving tendencies to an acceleration tendency class, a turning tendency class, and a mileage tendency class.

The curation device may calibrate the driver driving tendencies based on driver satisfaction with a previously-determined curation target vehicle.

In one embodiment, the curation device may classify the driver satisfaction into acceleration performance satisfaction, turning performance satisfaction, and mileage performance satisfaction. Furthermore, the curation device may calibrate the driver driving tendencies by assigning a weight to the acceleration tendency class according to the acceleration performance satisfaction, a weight to the turning tendency class according to the turning performance satisfaction, and a weight to the mileage tendency class according to the mileage performance satisfaction.

The curation device may determine the vehicle character to an acceleration performance class, a turning performance class and a mileage performance class.

The curation device may calculate first coordinates corresponding to the driver driving tendencies and second coordinates corresponding to the vehicle character.

The curation device may calculate the similarity based on a distance between the first coordinates and the second coordinates.

The distance may include a Euclidean distance.

The curation device may determine that the similarity is greater as the distance between the first coordinates and the second coordinates is smaller, and determine a vehicle character having the maximum similarity as the curation target vehicle.

According to an aspect of the present disclosure, A vehicle curation method includes: obtaining driving information of a driver, obtaining the driving information from the vehicle and storing the driving information for each driver and specification information of a new vehicle, receiving driving information corresponding to driver information when the driver information is input and determining driver driving tendencies, determining a vehicle character based on the specification information of the new vehicle, and determining a curation target vehicle based on a similarity between the driver driving tendencies and the vehicle character.

The determining of the driver driving tendencies may include setting the driver driving tendencies to an acceleration tendency class, a turning tendency class, and a mileage tendency class.

The vehicle curation method may further include calibrating the driver driving tendencies based on driver satisfaction with a previously-determined curation target vehicle.

In one embodiment, the calibrating of the driver driving tendencies may include: classifying the driver satisfaction into acceleration performance satisfaction, turning performance satisfaction, and mileage performance satisfaction; and calibrating the driver driving tendencies by assigning a weight to the acceleration tendency class according to the acceleration performance satisfaction, a weight to the turning tendency class according to the turning performance satisfaction, and a weight to the mileage tendency class according to the mileage performance satisfaction.

In another embodiment, the determining of the vehicle character may include setting the vehicle character to an acceleration performance class, a turning performance class and a mileage performance class based on the specification information of the new vehicle.

The vehicle curation method may further include calculating first coordinates corresponding to the driver driving tendencies and second coordinates corresponding to the vehicle character.

The vehicle curation method may further include calculating the similarity based on a distance between the first coordinates and the second coordinates.

The distance may include a Euclidean distance.

The vehicle curation method may further include determining that the similarity is greater as the distance between the first coordinates and the second coordinates is smaller, and determining a vehicle character having the maximum similarity as the curation target vehicle.

### BRIEF DESCRIPTION OF THE DRAWINGS

The above and other objects, features and advantages of the present disclosure should be more apparent from the following detailed description taken in conjunction with the accompanying drawings:

FIG. 1 is a diagram illustrating a configuration of a vehicle curation system according to an embodiment of the present disclosure;

FIG. 2 is a diagram illustrating a configuration of a curation device according to an embodiment of the present disclosure;

FIG. 3 is a diagram illustrating a configuration of a server according to an embodiment of the present disclosure;

FIG. 4 is a diagram showing a configuration of a vehicle according to an embodiment of the present disclosure;

FIG. 5 is a diagram schematically illustrating acceleration tendency classes according to an embodiment of the present disclosure;

FIG. 6 is a diagram schematically illustrating turning tendency classes according to an embodiment of the present disclosure;

FIG. 7 is a diagram schematically illustrating mileage tendency classes according to an embodiment of the present disclosure;

FIG. 8 is a diagram schematically illustrating an acceleration performance class according to an embodiment of the present disclosure;

FIG. 9 is a diagram schematically illustrating turning performance class according to an embodiment of the present disclosure;

FIG. 10 is a diagram schematically illustrating mileage tendency class according to an embodiment of the present disclosure;

FIG. 11 is a diagram schematically illustrating a similarity calculation method according to an embodiment of the present disclosure;

FIG. 12 is a diagram illustrating a vehicle curation method according to an embodiment of the present disclosure; and

FIG. 13 is a diagram illustrating a configuration of a computing system for executing a method according to an embodiment of the present disclosure.

The drawings described herein are for illustration purposes only and are not intended to limit the scope of the present disclosure in any way.

### DETAILED DESCRIPTION

Hereinafter, some embodiments of the present disclosure are described in detail with reference to the exemplary drawings. In adding the reference numerals to the components of each drawing, it should be noted that the identical or equivalent component is designated by the identical numeral even when they are displayed on other drawings. Further, in describing the embodiment of the present disclosure, a detailed description of well-known features or functions will be ruled out in order not to unnecessarily obscure the gist of the present disclosure.

In describing the components of the embodiment according to the present disclosure, terms such as first, second, “A”, “B”, (a), (b), and the like may be used. These terms are merely intended to distinguish one component from another component, and the terms do not limit the nature, sequence or order of the constituent components. Unless otherwise defined, all terms used herein, including technical or scientific terms, have the same meanings as those generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

When a component, device, element, or the like of the present disclosure is described as having a purpose or performing an operation, function, or the like, the component, device, or element should be considered herein as being “configured to” meet that purpose or to perform that operation or function.

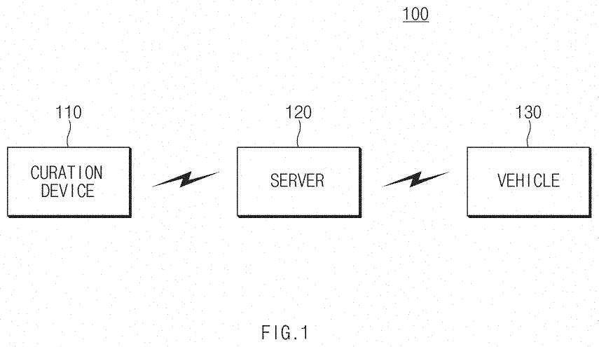

FIG. 1 is a diagram illustrating a configuration of a vehicle curation system according to an embodiment of the present disclosure.

Referring to FIG. 1, a vehicle curation system 100 may include a curation device 110, a server 120, and a vehicle 130.

When a driver intends to purchase a new vehicle, the curation device 110 may determine and recommend a new vehicle based on a driver driving tendencies. Specifically, when driver information is input, the curation device 110 may receive driving information corresponding to the driver information from the server 120. Moreover, the curation device 110 may further determine the driver driving tendencies, and a vehicle character based on the specification information of the new vehicle, and also determine and recommend a curation target vehicle based on the similarity between the driver driving tendencies and the vehicle character.

The server 120 may obtain the driving information from the vehicle 130 and store the driving information for each driver, and may store the specification information of the new vehicle. Here, the specification information may refer to information including dimensions or weight indicating the performance and characteristics of the vehicle.

The vehicle 130 may obtain the driving information of the driver.

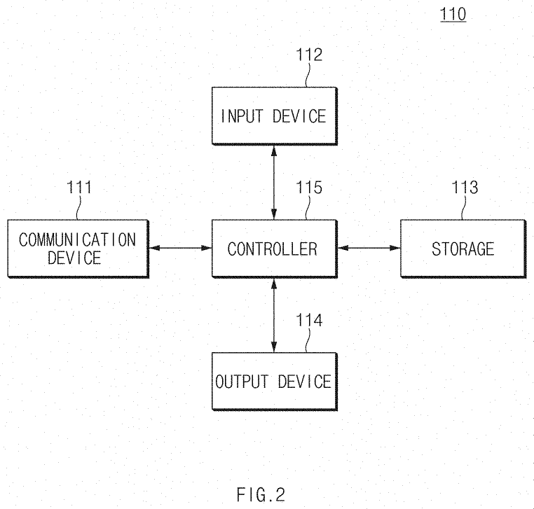

FIG. 2 is a diagram illustrating a configuration of a curation device according to an embodiment of the present disclosure.

Referring to FIG. 2, the curation device 110 may include a communication device 111, an input device 112, storage 113, an output device 114, and a controller 115.

The communication device 111 may wirelessly communicate with the server 120. According to an embodiment, the communication device 111 may communicate with the server 120 in various wireless communication methods including, for example, Wi-Fi, WiBro, Global System for Mobile Communication (GSM), Code Division Multiple Access (CDMA), Wideband Code Division Multiple Access (WCDMA), Universal Mobile Telecommunication System (UMTS), Time Division Multiple Access (TDMA), Long Term Evolution (LTE).

The input device 112 may receive driver information, a preferred vehicle size, or a preferred vehicle type. Further, the input device 112 may receive driver satisfaction information. According to an embodiment of the present disclosure, the input device 112 may be implemented as a button, a touch screen, a touch pad, or the like, which the driver is able to operate, and may be implemented as a voice recognition sensor capable of detecting a voice.

The storage 113 may store at least one or more algorithms for performing operations or execution of various commands for the operation of a curation device according to an embodiment of the present disclosure. The storage 113 may include at least one medium of a flash memory, a hard disk, a memory card, a Read-Only Memory (ROM), a Random Access Memory (RAM), an Electrically Erasable Programmable Read-Only Memory (EEPROM) Memory, a Programmable Read-Only Memory (PROM), a magnetic memory, a magnetic disk, and an optical disk.

The output device 114 may output determined information when the controller 115 determines a curation target vehicle. According to an embodiment, the output device 114 may be implemented as a display device, a sound output device, or the like.

The controller 115 may be implemented by various processing devices such as a microprocessor incorporating a semiconductor chip capable of operating or executing various instructions or the like and may control an operation of the curation device according to an embodiment of the present disclosure.

The controller 115 may determine a vehicle preferred by the driver. The controller 115 may determine a vehicle preferred by the driver when information on a vehicle size and a vehicle type preferred by the driver is input, and determine driver information when a driver ID is input. Here, the vehicle size may include a light-weight car, a small car, a medium car, and a large car, and the vehicle type may include a sedan, an SUV, a CUV, a wagon, a minivan, and a pickup truck.

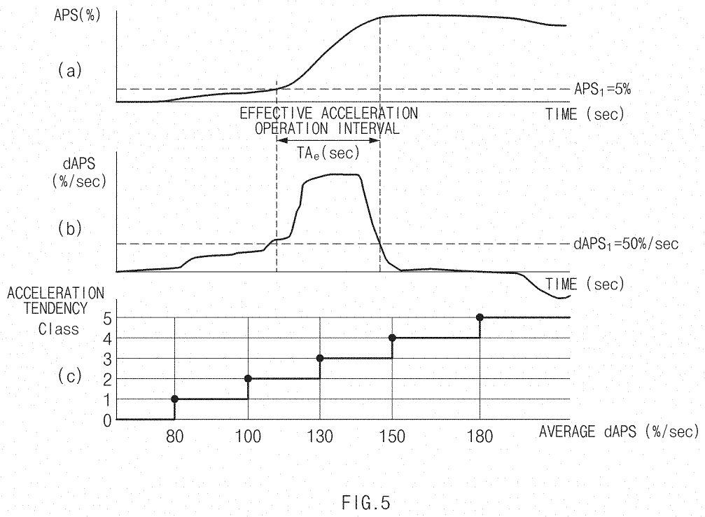

When the information on the driver's preferred vehicle size and type and the driver information are obtained, the controller 115 may receive driving information corresponding to the driver information from the server 120 and determines the driver driving tendencies based on the received driving information. According to an embodiment of the present disclosure, the controller 115 may set the driver driving tendencies to an acceleration tendency class, a turning tendency class, and a mileage tendency class. A more detailed description related thereto will be given with reference to FIGS. 5 to 7.

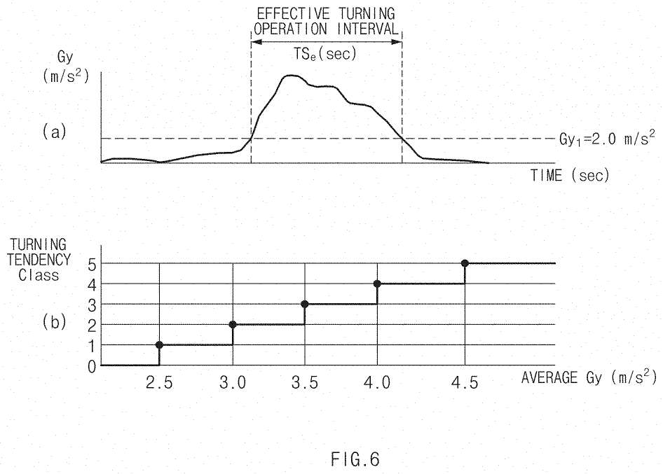

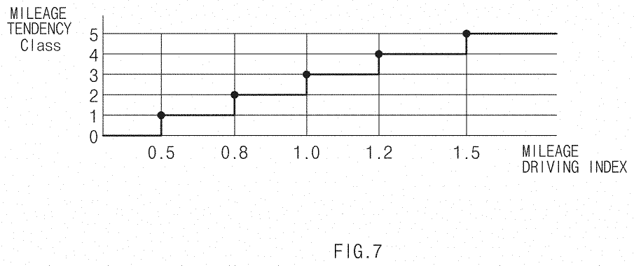

FIG. 5 is a diagram schematically illustrating acceleration tendency classes according to an embodiment of the present disclosure, FIG. 6 is a diagram schematically illustrating turning tendency classes according to an embodiment of the present disclosure, and FIG. 7 is a diagram schematically illustrating mileage tendency classes according to an embodiment of the present disclosure.

Referring to FIG. 5, the controller 115 may set an acceleration tendency class based on a degree of pressure imposed on an accelerator pedal by the driver. The acceleration tendency class may be used as a factor for determining which acceleration tendency the driver requests. According to the embodiment, the controller 115 may calculate an average BAPS using Equation 1 in an interval (effective acceleration operation interval, TAₑ) in which an accelerator pedal sensing value is equal to or greater than a valid sensing value (APS₁=5%) among accelerator pedal sensing values obtained when the driver presses the accelerator pedal as shown in (a) of FIG. 5, and the amount of a change in the accelerator pedal sensing value is equal to or greater than dAPS' (=50%/sec) as shown in (b) of FIG. 5.

Average dAPS=ΣdAPS/TAₑ <Equation 1>

According to an embodiment, as shown in (c) of FIG. 5, the controller 115 may set the acceleration tendency class to 1 when the average dAPS is 80, set the acceleration tendency class to 2 when the average dAPS is 100, set the acceleration tendency class to 3 when the average dAPS is 130, set the acceleration tendency class to 4 when the average dAPS is 150, and set the acceleration tendency class to 5 when the average dAPS is 180.

As shown in FIG. 6, the controller 115 may set the turning tendency class based on a lateral acceleration of the vehicle. The turning tendency class may be used as a factor for determining what kind of riding comfort the driver requires. According to an embodiment, as shown in (a) of FIG. 6, the controller 115 may calculate an average lateral acceleration using Equation 2, and set the turning tendency class using the average lateral acceleration, in an interval (valid turning operation interval, TSₑ) in which the absolute value |Gy₁| of the lateral acceleration is equal to or greater than a valid lateral acceleration (e.g., Gy₁=2.0 m/s²).

Average Gy=ΣGy/TSₑ <Equation 2>

According to an embodiment, as shown in (b) of FIG. 6, the controller 115 may set the turning tendency class to 1 when the lateral acceleration is 2.5, set the turning tendency class to 2 when the lateral acceleration is 3.0, set the turning tendency class to 3 when the lateral acceleration is 3.5, set the turning tendency class to 4 when the lateral acceleration is 4.5, and set the turning tendency class to 5 when the lateral acceleration is 5.0.

Referring to FIG. 7, the controller 115 may set the mileage tendency class based on a ratio of a cumulative average mileage of the driver's vehicle to an average mileage of the same vehicle model. According to an embodiment, the controller 115 may calculate a mileage driving index using Equation 3, and set a mileage tendency class based on the mileage driving index.

Mileage driving index(KFE)=Cumulative average mileage/average mileage of same vehicle model <Equation 3>

The controller 115 may determine that there is a driving tendency to increase a mileage (a long driving distance per unit fuel) when the mileage driving index is less than 1, and determine that there is a driving tendency to decrease a mileage when the mileage driving index exceeds 1.

According to an embodiment, as shown in FIG. 7, the controller 115 may set the mileage tendency class to 1 when the mileage driving index is 0.5, set the mileage tendency class to 2 when the mileage driving index is 0.8, set the mileage tendency class to 3 when the mileage driving index is 1.0, set the mileage tendency class to 4 when the mileage driving index is 1.2 and set the mileage tendency class to 5 when the mileage driving index is 1.5.

As described above, when the acceleration tendency class, the turning tendency class, and the mileage tendency class are set based on the driver's driving information, the controller 115 may determine the driver driving tendencies. According to an embodiment of the present disclosure, determining the driver's driving tendencies is not limited to setting the acceleration tendency class, the turning tendency class, and the mileage tendency class, but setting other tendencies may be also possible.

When the driver driving tendencies are determined, the controller 115 may correct the driver driving tendencies based on a previously stored satisfaction. According to an embodiment, the controller 115 may output to the driver, a message asking whether the driver is satisfied with a previously-provided vehicle curation through the output device 114. The present disclosure is not limited thereto, and the controller 115 may output a satisfaction survey for a previously-provided vehicle curation through the driver's smartphone.

When it is determined that the previously-provided vehicle curation is satisfied based on a driver input, the controller 115 may maintain the driver driving tendencies included in the previously-provided vehicle curation. That is, the preset acceleration tendency class, the turning tendency class, and the mileage tendency class may be maintained.

On the other hand, when it is determined based on the driver input that a driver is dissatisfied with the previously-provided vehicle curation, the controller 115 may classify driver satisfaction into acceleration performance satisfaction, turning performance satisfaction, and mileage performance satisfaction and update parameters respectively by assigning a weight to the acceleration tendency class according to an acceleration performance satisfaction score, a weight to the turning tendency class according to a turning performance satisfaction score, and a weight to the mileage tendency class according to a mileage performance satisfaction store to calibrate the driver driving tendencies.

When the driving tendencies of the driver are calibrated, the controller 115 may calculate a first coordinate corresponding to the driving tendencies of the driver. For example, when the acceleration tendency class is set to 1, the turning tendency class is 3, and the mileage tendency class is set to 2 after calibration, the controller 115 may set the driver driving tendencies to (1, 3, 2).

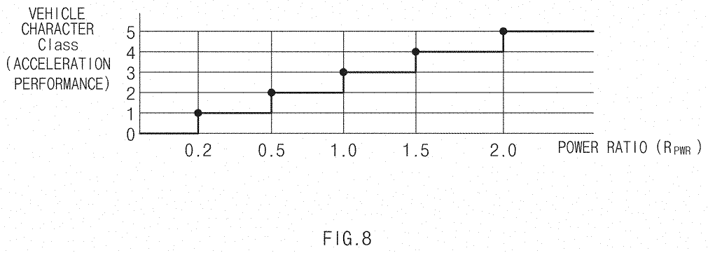

The controller 115 may determine a vehicle character corresponding to the vehicle size and type information preferred by the driver based on the specification information of a new vehicle, which is received from the server 120. According to an embodiment, the controller 115 may set the vehicle character to the acceleration performance class, the turning performance class, and the mileage performance class. A more detailed description related thereto will be given with reference to FIGS. 8 to 10.

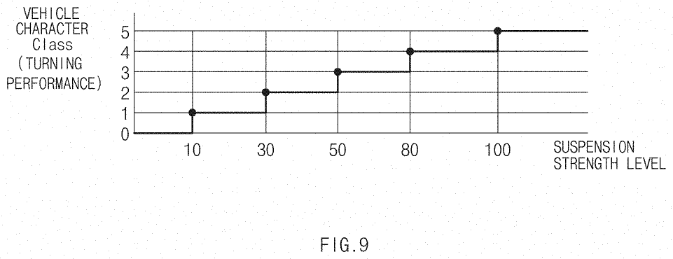

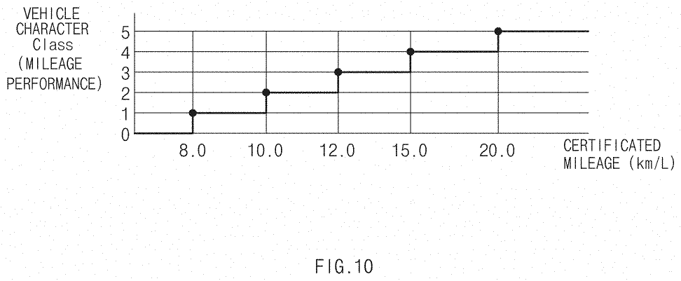

FIG. 8 is a diagram schematically illustrating an acceleration performance class according to an embodiment of the present disclosure, FIG. 9 is a diagram schematically illustrating turning performance class according to an embodiment of the present disclosure, and FIG. 10 is a diagram schematically illustrating mileage tendency class according to an embodiment of the present disclosure.

As shown in FIG. 8, the controller 115 may calculate a power ratio using Equation 4 based on a power-to-weight ratio of the vehicle, and set an acceleration performance class using the power ratio.

Power Ratio(R_{PWR})=Maximum Vehicle Power/Unloaden Vehicle Weight <Equation 4>

The controller 115 may determine that the acceleration performance increases as the power ratio is larger, and determine that the acceleration performance decreases as the power ratio is smaller.

According to an embodiment, as shown in FIG. 8, the controller 115 may set the acceleration performance class to 1 when the power ratio is 0.2, set the acceleration performance class to 2 when the power ratio is 0.5, set the acceleration performance class to 3 when the power ratio is 1.0, set the acceleration performance class to 4 when the power ratio is 1.5, and set the acceleration performance class to 5 when the power ratio is 2.0.

As shown in FIG. 9, the controller 115 may set a turning performance class based on a strength level of a vehicle suspension. The controller 115 may determine that vehicle ride comfort is harder as the strength level of the suspension increases, and determine that the vehicle ride comfort is softer as the strength level of the suspension decreases.

According to an embodiment, as shown in FIG. 9, the controller 115 may set the turning performance class to 1 when the strength level of the suspension is 10, set the turning performance class to 2 when the strength level of the suspension is 30, set the turning performance class to 3 when the strength level of the suspension is 50, set the turning performance class to 4 when the strength level of the suspension is 80 and set the turning performance class to 5 when the strength level of the suspension is 100.

As shown in FIG. 10, the controller 115 may set a mileage performance character based on the mileage of the vehicle. According to the embodiment, the controller 115 may set the mileage performance class to 1 when the mileage is 8 (km/L), set the mileage performance class to 2 when the mileage is 10 (km/L), set the mileage performance class to 3 when the mileage is 12 (km/L), set the mileage performance class to 4 when the mileage is 15 (km/L), and set the mileage performance class to 5 when the mileage is 20 (km/L).

The controller 115 may calculate second coordinates corresponding to the vehicle character. For example, when the acceleration performance class is 3, the turning performance class is 1, and the mileage performance class is set to 2, the controller 115 may calculate the second coordinates corresponding to the vehicle character to (3,1,2). When there is a plurality of new vehicles, the controller 115 may calculate a plurality of second coordinates.

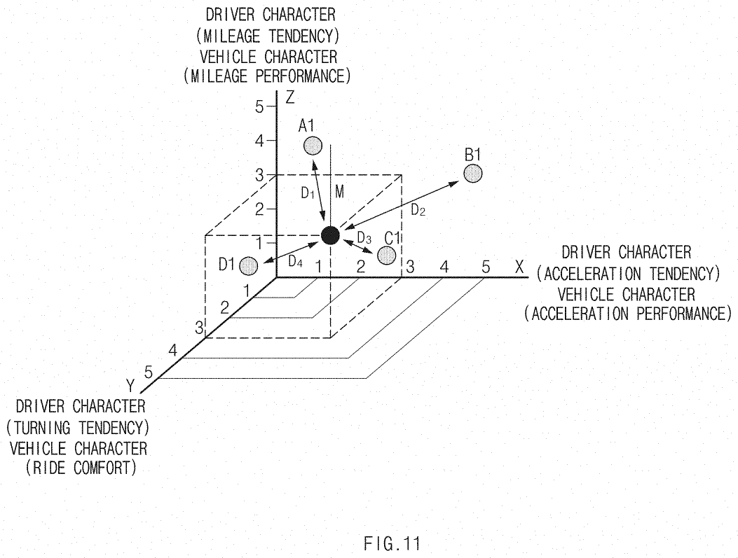

The controller 115 may determine a vehicle character corresponding to the driver driving tendencies. According to an embodiment, the controller 115 may calculate a similarity between the driver driving tendencies and the vehicle character, and determine a curation target vehicle according to the similarity. A more detailed description will be given with reference to FIG. 11.

FIG. 11 is a diagram schematically illustrating a similarity calculation method according to an embodiment of the present disclosure.

As shown in FIG. 11, the controller 115 may calculate a similarity based on the distance between first coordinates M calculated corresponding to a driver driving tendency and second coordinates calculated corresponding to a vehicle character. When the controller 115 determines vehicle characters for vehicles A, B, C, and D, respectively, the second coordinates may include A1, B1, C1, and D1.

The controller 115 may calculate a distance D1 between the first coordinates and coordinates A1 corresponding to the vehicle character of the vehicle A, a distance D2 between the first coordinates and coordinates A2 corresponding to the vehicle character of the vehicle B, a distance D3 between the first coordinates and coordinates A3 corresponding to the vehicle character of the vehicle C, and a distance D4 between the first coordinates and coordinates A4 corresponding to the vehicle character of the vehicle D, and calculate a similarity based on the distances D1 to D4.

According to an embodiment, the controller 115 may calculate a distance Dcharacter between the first coordinates and the second coordinates using Equation 5 for calculating the Euclidean distance.

$${D}_{Character} = \sqrt{{\sum }_{i = 1}^{n} {( {P}_{i} - {Q}_{i} )}^{2}} \qquad 〈 Equation 5 〉$$

According to an embodiment, the controller 115 may determine that the similarity is greater as the distance between the first coordinates and the second coordinates, that is, the D_{character} is smaller, and determine a vehicle character having the maximum similarity. The controller 115 may determine a vehicle having the vehicle character having the maximum similarity as a curation target vehicle. According to an embodiment, the controller 115 may determine the vehicle C as a curation target vehicle.

When the curation target vehicle is determined, the controller 115 may recommend the determined vehicle to the driver, and according to an embodiment, may output the determined vehicle information through the output device 114.

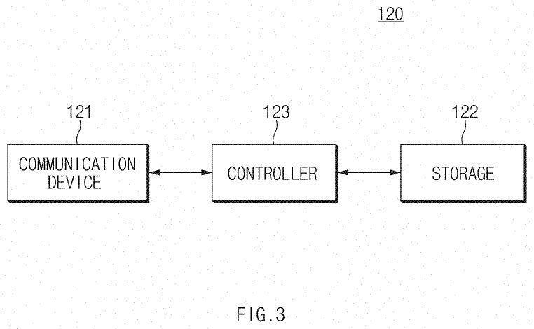

FIG. 3 is a diagram illustrating a configuration of a server according to an embodiment of the present disclosure.

Referring to FIG. 3, the server 120 may include a communication device 121, storage 122, and a controller 123.

The communication device 121 may wirelessly communicate with the curation device 110 and the vehicle 130. According to an embodiment, the communication device 121 may perform wireless communication with the curation device 110 and the vehicle 130 through various wireless communication methods including, for example, Wi-Fi, WiBro, Global System for Mobile Communication (GSM), Code Division Multiple Access (CDMA), Wideband Code Division Multiple Access (WCDMA), Universal Mobile Telecommunication System (UMTS), Time Division Multiple Access (TDMA), Long Term Evolution (LTE).

The storage 122 may store pieces of driver driving information obtained from the at least one or more vehicles 130 for each driver. In addition, the storage 122 may store the specification information of a new vehicle. Further, the storage 122 may store at least one or more algorithms for performing operations or execution of various commands for the operation of a server according to an embodiment of the present disclosure. The storage 122 may include at least one medium of a flash memory, a hard disk, a memory card, a Read-Only Memory (ROM), a Random Access Memory (RAM), an Electrically Erasable Programmable Read-Only Memory (EEPROM), a Programmable Read-Only Memory (PROM), a magnetic memory, a magnetic disk, and an optical disk.

The controller 123 may be implemented by various processing devices such as a microprocessor incorporating a semiconductor chip capable of operating or executing various instructions or the like and may control an operation of the server according to an embodiment of the present disclosure.

The controller 123 may receive pieces of driver driving information obtained from the at least one or more vehicles 130 and store the pieces of driver driving information for each driver. When a new vehicle is released, the specification information of the new vehicle may be continuously updated.

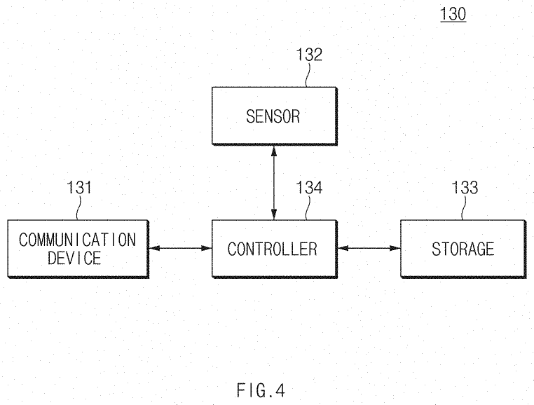

FIG. 4 is a diagram showing a configuration of a vehicle according to an embodiment of the present disclosure.

Referring to FIG. 4, the vehicle 130 may include a communication device 131, a sensor 132, storage 133, and a controller 134.

The communication device 131 may wirelessly communicate with the server 120. According to an embodiment, the communication device 131 may communicate with the server 120 in various wireless communication methods including, for example, Wi-Fi, WiBro, Global System for Mobile Communication (GSM), Code Division Multiple Access (CDMA), Wideband Code Division Multiple Access (WCDMA), Universal Mobile Telecommunication System (UMTS), Time Division Multiple Access (TDMA), Long Term Evolution (LTE).

The sensor 132 may obtain driving information of the vehicle. According to an embodiment, the sensor 132 may include an accelerator pedal sensor for sensing a degree of pressure imposed on an accelerator pedal by the driver, a vehicle speed sensor for obtaining a vehicle speed, and a lateral acceleration sensor for obtaining a lateral acceleration of the vehicle.

The storage 133 may store at least one or more algorithms for performing operations or execution of various commands for the operation of a vehicle according to an embodiment of the present disclosure. The storage 133 may include at least one medium of a flash memory, a hard disk, a memory card, a Read-Only Memory (ROM), a Random Access Memory (RAM), an Electrically Erasable Programmable Read-Only Memory (EEPROM), a Programmable Read-Only Memory (PROM), a magnetic memory, a magnetic disk, and an optical disk.

The controller 134 may be implemented by various processing devices such as a microprocessor incorporating a semiconductor chip capable of operating or executing various instructions or the like and may control an operation of the vehicle according to an embodiment of the present disclosure. According to an embodiment, the controller 134 may transmit the driving information of the vehicle obtained by the sensor 132 to the server 120.

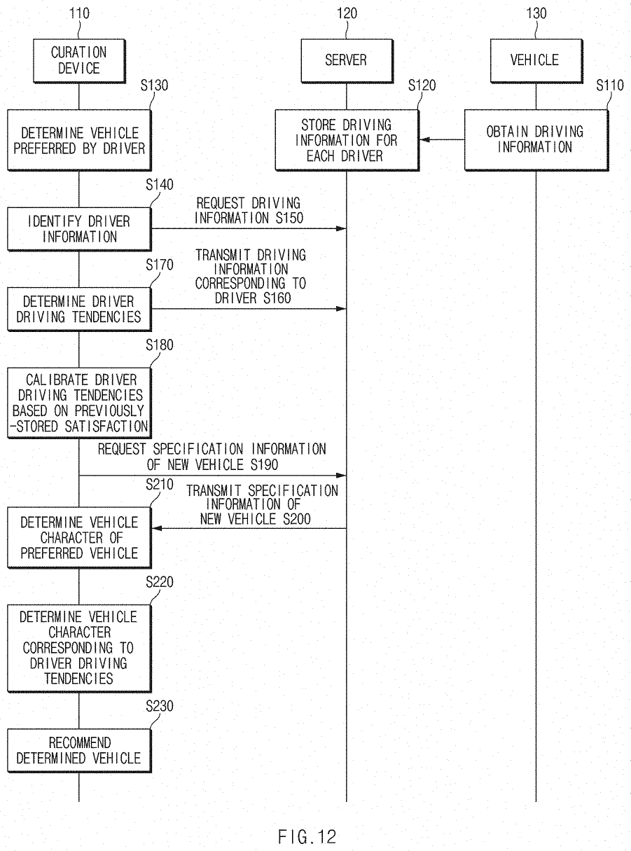

FIG. 12 is a diagram illustrating a vehicle curation method according to an embodiment of the present disclosure; and

Referring to FIG. 12, when the vehicle 130 obtains driving information (in step S110), the vehicle 130 may transmit the driving information to the server 120. The server 120 may receive the driving information from a plurality of vehicles 130, and may store the received information for each driver (in step S120).

The curation device 110 may determine a preferred vehicle based on information input by the driver (in step S130). In step S130, the curation device 110 may receive information on a vehicle size and a vehicle type which are preferred by the driver, and may determine the preferred vehicle.

The curation device 110 may identify driver information based on the information input by the driver (in step S140). In step S140, the curation device 110 may receive a driver ID and identify the driver information.

When the driver information is identified, the curation device 110 may request driving information corresponding to the driver information to the server 120 (in step S150). The server 120 may transmit the driving information corresponding to the driver information to the curation device 110 (in step S160), and determine driver driving tendencies based on the received driving information (in step S170).

In step S170, the curation device 110 may set the driver driving tendencies to an acceleration tendency class, a turning tendency class, and a mileage tendency class. A more detailed description related thereto refers to the description given with reference to FIGS. 5 to 7.

When the driver driving tendencies are determined, the curation device 110 may calibrate the driver driving tendencies based on a previously stored satisfaction (in step S180). In step S180, the curation device 110 may maintain the driver's driving tendencies included in the previously-provided vehicle curation when it is determined that the previously-provided vehicle curation is satisfied based on the driver's input. That is, the preset acceleration tendency class, the turning tendency class, and the mileage tendency class may be maintained.

On the other hand, when it is determined that a driver is dissatisfied with the previously-provided vehicle curation based on the driver's input, the curation device 110 may classify driver satisfaction into acceleration performance satisfaction, turning performance satisfaction, and mileage performance satisfaction, and the curation device 110 may update parameters respectively by assigning a weight to the acceleration tendency class according to an acceleration performance satisfaction score, a weight to the turning tendency class according to a turning performance satisfaction score, and a weight to the mileage tendency class according to a mileage performance satisfaction score to calibrate the driver driving tendencies.

When the driving tendencies of the driver are calibrated in step S180, the curation device 110 may calculate first coordinates corresponding to the driving tendencies of the driver. For example, when the acceleration tendency class is set to 1, the turning tendency class is 3, and the mileage tendency class is set to 2 after calibration, the curation device 110 may set the driver driving tendencies to (1, 3, 2).

In step S190, the curation device 110 may request the specification information of a new vehicle to the server 120, In step S200, the server 120 may transmit the specification information of a new vehicle to the curation device 110.

In step S210, the curation device 110 may determine a vehicle character corresponding to the vehicle size and type information preferred by the driver based on the specification information of a new vehicle, which is received from the server 120. In step S210, according to an embodiment, the curation device 110 may set the vehicle character to the acceleration performance class, the turning performance class, and the mileage tendency class. A more detailed description related thereto refers to the description given with reference to FIGS. 8 to 10.

In step S210, the curation device 110 may calculate second coordinates corresponding to the vehicle character. For example, when the acceleration performance class is 3, the turning performance class is 1, and the mileage performance class is set to 2, the controller 115 may calculate the second coordinates corresponding to the vehicle character to (3,1,2). When there is a plurality of new vehicles, the controller 115 may calculate a plurality of second coordinates.

The curation device 110 may determine a vehicle character corresponding to the driver driving tendencies (in step S220). In step S220, according to an embodiment, the curation device 110 may calculate a similarity between the driver driving tendencies and the vehicle character, and determine a curation target vehicle according to the similarity. A more detailed description related thereto refers to the description given with reference to FIG. 11.

In step S220, according to an embodiment, the curation device 110 may determine that the similarity is greater as the distance between the first coordinates and the second coordinates, that is, D character is smaller, and determine a vehicle character having the maximum similarity. The curation device 110 may determine a vehicle having the vehicle character having the maximum similarity as a curation target vehicle.

When the curation target vehicle is determined, the curation device 110 may recommend the determined vehicle to the driver (in step S230). In step S230, according to an embodiment, the determined vehicle information may be output through the output device 114.

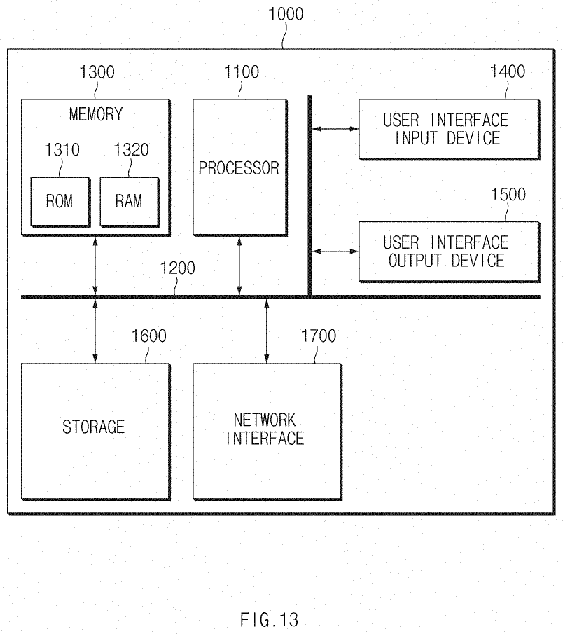

FIG. 13 is a diagram illustrating a configuration of a computing system for executing a method according to an embodiment of the present disclosure;

Referring to FIG. 13, a computing system 1000 may include at least one processor 1100, a memory 1300, a user interface input device 1400, a user interface output device 1500, storage 1600, and a network interface 1700, which are connected with each other via a bus 1200.

The processor 1100 may be a central processing unit (CPU) or a semiconductor device that processes instructions stored in the memory 1300 and/or the storage 1600. The memory 1300 and the storage 1600 may include various types of volatile or non-volatile storage media. For example, the memory 1300 may include a ROM (Read Only Memory) 1310 and a RAM (Random Access Memory) 1320.

Thus, the operations of the method or the algorithm described in connection with the embodiments disclosed herein may be embodied directly in hardware or a software module executed by the processor 1100, or in a combination thereof. The software module may reside on a storage medium (that is, the memory 1300 and/or the storage 1600) such as a RAM, a flash memory, a ROM, an EPROM, an EEPROM, a register, a hard disk, a removable disk, and a CD-ROM. The exemplary storage medium may be coupled to the processor 1100, and the processor 1100 may read information out of the storage medium and may record information in the storage medium. Alternatively, the storage medium may be integrated with the processor 1100. The processor and the storage medium may reside in an application specific integrated circuit (ASIC). The ASIC may reside within a user terminal. In another case, the processor and the storage medium may reside in the user terminal as separate components.

The above description is merely illustrative of the technical idea of the present disclosure, and various modifications and variations may be made without departing from the essential characteristics of the present disclosure by those having ordinary skill in the art to which the present disclosure pertains.

Therefore, the exemplary embodiments of the present disclosure are provided to explain the spirit and scope of the present disclosure, but not to limit them, so that the spirit and scope of the present disclosure is not limited by the embodiments. The scope of protection of the present disclosure should be interpreted by the following claims, and all technical ideas within the scope equivalent thereto should be construed as being included in the scope of the present disclosure.

According to the vehicle curation system and method according to an embodiment of the present disclosure, it is possible to maximize a driver's satisfaction by facilitating selection of a vehicle that matches the driver's tendencies when the driver purchases a new car.

Hereinabove, although the present disclosure has been described with reference to exemplary embodiments and the accompanying drawings, the present disclosure is not limited thereto, but may be variously modified and altered by those having ordinary skill in the art to which the present disclosure pertains without departing from the spirit and scope of the present disclosure.

What is claimed is:

1. A vehicle curation system comprising:
a vehicle configured to obtain driving information of a driver;
a server configured to: obtain the driving information from the vehicle, and store the driving information for each driver and specification information of a new vehicle; and
a curation device configured to:
receive driving information corresponding to driver information from the server when the driver information is input,
determine driver driving tendencies,
determine a vehicle character based on the specification information of the new vehicle, and
determine a curation target vehicle based on a similarity between the driver driving tendencies and the vehicle character.

2. The vehicle curation system of claim 1, wherein the curation device is configured to set the driver driving tendencies to an acceleration tendency class, a turning tendency class, and a mileage tendency class.

3. The vehicle curation system of claim 2, wherein the curation device is configured to calibrate the driver driving tendencies based on driver satisfaction with a previously-determined curation target vehicle.

4. The vehicle curation system of claim 3, wherein the curation device is configured to:
classify the driver satisfaction into acceleration performance satisfaction, turning performance satisfaction, and mileage performance satisfaction, and
calibrate the driver driving tendencies by assigning a weight to the acceleration tendency class according to the acceleration performance satisfaction, a weight to the turning tendency class according to the turning performance satisfaction, and a weight to the mileage tendency class according to the mileage performance satisfaction.

5. The vehicle curation system of claim 1, wherein the curation device is configured to determine the vehicle character to an acceleration performance class, a turning performance class and a mileage performance class.

6. The vehicle curation system of claim 1, wherein the curation device is configured to calculate first coordinates corresponding to the driver driving tendencies and second coordinates corresponding to the vehicle character.

7. The vehicle curation system of claim 6, wherein the curation device is configured to calculate the similarity based on a distance between the first coordinates and the second coordinates.

8. The vehicle curation system of claim 7, wherein the distance includes a Euclidean distance.

9. The vehicle curation system of claim 7, wherein the curation device is configured to:
determine that the similarity is greater as the distance between the first coordinates and the second coordinates is smaller, and
determine a vehicle character having a maximum similarity as the curation target vehicle.

10. A vehicle curation method comprising:
obtaining driving information of a driver;
obtaining the driving information from a vehicle and storing the driving information for each driver and specification information of a new vehicle;
receiving driving information corresponding to driver information when the driver information is input and determining driver driving tendencies;
determining a vehicle character based on the specification information of the new vehicle; and
determining a curation target vehicle based on a similarity between the driver driving tendencies and the vehicle character.

11. The vehicle curation method of claim 10, wherein the determining of the driver driving tendencies includes
setting the driver driving tendencies to an acceleration tendency class, a turning tendency class, and a mileage tendency class.

12. The vehicle curation method of claim 11, further comprising:
calibrating the driver driving tendencies based on driver satisfaction with a previously-determined curation target vehicle.

13. The vehicle curation method of claim 12, wherein the calibrating of the driver driving tendencies includes:
classifying the driver satisfaction into acceleration performance satisfaction, turning performance satisfaction, and mileage performance satisfaction, and
calibrating the driver driving tendencies by assigning a weight to the acceleration tendency class according to the acceleration performance satisfaction, a weight to the turning tendency class according to the turning performance satisfaction, and a weight to the mileage tendency class according to the mileage performance satisfaction.

14. The vehicle curation method of claim 10, wherein the determining of the vehicle character includes: setting the vehicle character to an acceleration performance class, a turning performance class and a mileage performance class based on the specification information of the new vehicle.

15. The vehicle curation method of claim 10, further comprising:
calculating first coordinates corresponding to the driver driving tendencies and second coordinates corresponding to the vehicle character.

16. The vehicle curation method of claim 15, further comprising:
calculating the similarity based on a distance between the first coordinates and the second coordinates.

17. The vehicle curation method of claim 16, wherein the distance includes a Euclidean distance.

18. The vehicle curation method of claim 16, further comprising:
determining that the similarity is greater as the distance between the first coordinates and the second coordinates is smaller; and
determining a vehicle character having a maximum similarity as the curation target vehicle.
